(19) United States
(12) Patent Application Publication
(10) Pub. No.: US 2017/0270071 A1
(43) Pub. Date: Sep. 21, 2017

(54) NETWORK DEVICE

(71) Applicant: BOTHHAND ENTERPRISE INC., Tainan City (TW)

(72) Inventors: Chung-Cheng Fan, Taoyuan City (TW); Yung-Ming Pan, Taoyuan City (TW)

(21) Appl. No.: 15/206,081

(22) Filed: Jul. 8, 2016

(30) Foreign Application Priority Data
Mar. 21, 2016 (TW) 105108661

(51) Int. Cl. G06F 13/40; G06F 13/42

(52) U.S. Cl. CPC G06F 13/4068; G06F 13/4282

(57) ABSTRACT

A network device for interfacing network communication between equipment and a cable, and for filtering common-mode noise without changing winding inductances is provided and includes an equipment port connected to the equipment, a cable port connected to the cable, and a signal transmission unit. The signal transmission unit includes a primary channel connected to the equipment port for transmission of a signal, a secondary channel connected to the cable port for transmission of the signal, an isolation transformer connected between the primary channel and the secondary channel for coupling the signal, and a noise filtering module connected to one of the primary channel and the secondary channel for grounding common-mode noise.

### CROSS-REFERENCE TO RELATED APPLICATION

This application claims priority of Taiwanese Application No. 105108661, filed on Mar. 21, 2016.

### FIELD

The disclosure relates to a network device, and more particularly to a network device for interfacing network communication between equipment and a cable.

### BACKGROUND

A conventional network device for interfacing network communication between equipment and a cable is illustrated in FIGS. 1 and 2. The conventional network device includes an equipment port 81 configured to be electrically connected to the equipment, a cable port 82 configured to be electrically connected to the cable, and two signal transmission units 83 and 83′. The signal transmission units 83 and 83′ are used for signal transmission, each of which includes a primary channel 84 electrically connected to the equipment port 81 for transmission of a signal, a secondary channel 85 electrically connected to the cable port 82 for transmission of the signal, an isolation transformer 86 electrically connected between the primary channel 84 and the secondary channel 85 for coupling the signal from the primary channel 84 to the secondary channel 85, and two noise filtering modules 87 electrically connected to the isolation transformer 86.

The isolation transformer 86 includes a primary winding 861 and a secondary winding 862. Each of the primary winding 861 and the secondary winding 862 has a first winding segment 863, a second winding segment 864, and a center tap 865 between the first winding segment 863 and the second winding segment 864. Each of the two noise filtering modules 87 is connected to the center tap 865 of a respective one of the primary winding 861 and the secondary winding 862 for grounding common-mode noise accompanying the signal.

The center tap 865 is implemented as illustrated in FIG. 2 by drawing parts of wires of the first winding segment 863 and the second winding segment 864, respectively, and twisting together the parts of wires thus drawn. However, implementation of the center tap 865 by the above approach may change a number of turns of each of the primary winding 861 and the secondary winding 862, so the primary winding 861 and the secondary winding 862 may have unequal winding turns, thereby introducing errors while the primary winding 861 and the secondary winding 862 are inductively coupled.

### SUMMARY

Therefore, an object of the disclosure is to provide a network device for interfacing network communication between equipment and a cable, and for filtering common-mode noise without changing winding inductances.

According to the disclosure, the network device includes an equipment port configured to be electrically connected to the equipment, a cable port configured to be electrically connected to the cable, and a signal transmission unit.

The signal transmission unit includes a primary channel electrically connected to the equipment port for transmission of a signal, a secondary channel coupled to the primary channel and electrically connected to the cable port for transmission of the signal, an isolation transformer electrically connected between the primary channel and the secondary channel for coupling the signal from the primary channel to the secondary channel, and a noise filtering module electrically connected to one of the primary channel and the secondary channel for grounding common-mode noise.

### BRIEF DESCRIPTION OF THE DRAWINGS

Other features and advantages of the disclosure will become apparent in the following detailed description of the embodiments with reference to the accompanying drawings, of which:

FIG. 1 is a circuit diagram illustrating a conventional network device;

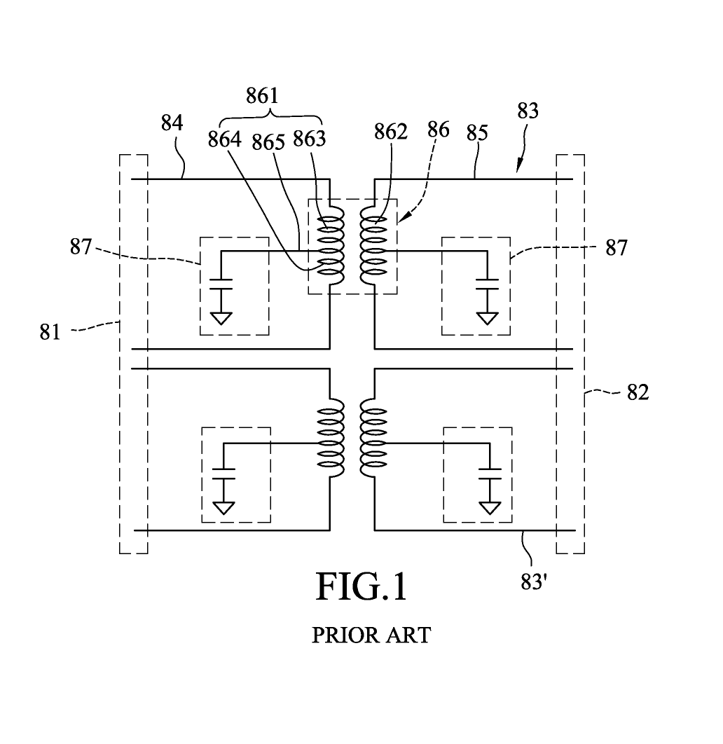

FIG. 2 is a schematic diagram illustrating implementation of an isolation transformer of the conventional network device;

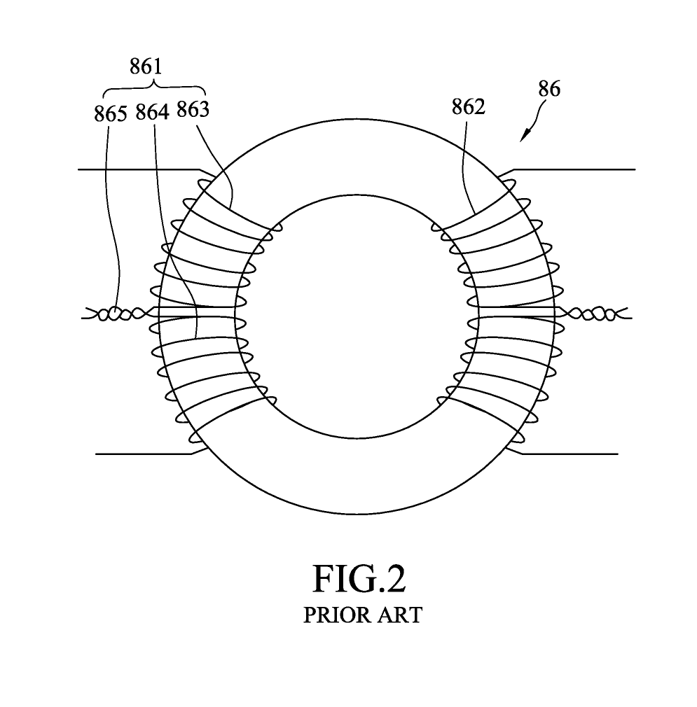

FIG. 3 is a circuit diagram illustrating a first embodiment of a network device according to the disclosure;

FIG. 4 is a circuit diagram illustrating a signal path of a network signal in the first embodiment;

FIG. 5 is a circuit diagram illustrating a signal path of common-mode noise in the first embodiment; and

FIG. 6 is a circuit diagram illustrating a second embodiment of the network device according to the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics. In addition, when two elements are described as being “coupled in series,” “connected in series” or the like, it is merely intended to portray a serial connection between the two elements without necessarily implying that the currents flowing through the two elements are identical to each other and without limiting whether or not an additional element is coupled to a common node between the two elements. Essentially, “a series connection of elements,” “a series coupling of elements” or the like as used throughout this disclosure should be interpreted as being such when looking at those elements alone.

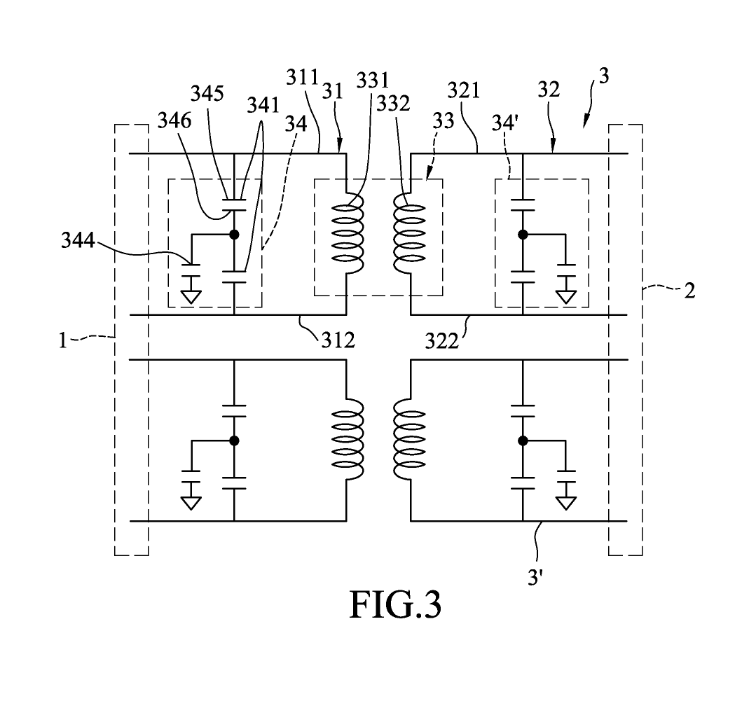

Referring to FIGS. 3 to 5, a first embodiment of a network device for interfacing network communication between equipment and a cable, and for filtering common-mode noise without changing winding inductances is illustrated. The equipment may be implemented as a network equipment, such as a computer or a router. The cable may be implemented as a network cable, such as a cable with an RJ-45 connector.

The network device includes an equipment port 1 configured to be electrically connected to the equipment, a cable port 2 configured to be electrically connected to the cable, and two signal transmission units 3 and 3′ each of which includes a primary channel 31 electrically connected to the equipment port 1 for transmission of a signal, a secondary channel 32 electrically connected to the cable port 2 for transmission of the signal, an isolation transformer 33 electrically connected between the primary channel 31 and the secondary channel 32 for coupling the signal from the primary channel 31 to the secondary channel 32, and two noise filtering modules 34 and 34′ electrically connected to a respective one of the primary channel 31 and the secondary channel 32 for grounding the common-mode noise.

The isolation transformer 33 includes a primary winding 331 electrically connected to the primary channel 31, and a secondary winding 332 electrically connected to the secondary channel 32. The primary channel 31 has a forward path 311 and a return path 312 each of which is electrically connected between the equipment port 1 and the isolation transformer 33, and electrically connected to a respective one of two ends of the primary winding 331 so that the forward path 311, the primary winding 331 and the return path 312 are connected in series. The secondary channel 32 has a forward path 321 and a return path 322 each of which is electrically connected between the cable port 2 and the isolation transformer 33, and electrically connected to a respective one of two ends of the secondary winding 332 so that the forward path 321, the secondary winding 332, and the return path 322 are connected in series. By coupled magnetic flux between the primary winding 331 and the secondary winding 332, a network signal is able to be coupled from the primary channel 31 to the secondary channel 32. Moreover, since the primary winding 331 and the secondary winding 332 are isolated from each other, the equipment and the cable may be protected from high voltage surges resulting from lightning strikes.

In this embodiment, the noise filtering module 34 is electrically connected between the forward path 311 and the return path 312 of the primary channel 31, and the noise filtering module 34′ is electrically connected between the forward path 321 and the return path 322 of the secondary channel 32. Because implementation of the noise filtering module 34 is similar to that of the noise filtering module 34′, only details of the noise filtering module 34 will be described.

The noise filtering module 34 includes two first bypass capacitors 341 each of which is electrically connected to a respective one of the forward path 311 and the return path 312, and a second bypass capacitor 344 electrically connected between each of the first bypass capacitors 341 and ground. Specifically, each of the first bypass capacitors 341 has a first end 345 electrically connected to a respective one of the forward path 311 and the return path 312, and a second end 346 electrically connected to one end of the second bypass capacitor 344 opposite to the ground.

The second bypass capacitor 344 is a high voltage isolation capacitor, which is capable of isolating the network device from the ground when lightning strikes occur, so that the first bypass capacitors 341 are prevented from influence of high voltage surges resulting from lightning strikes.

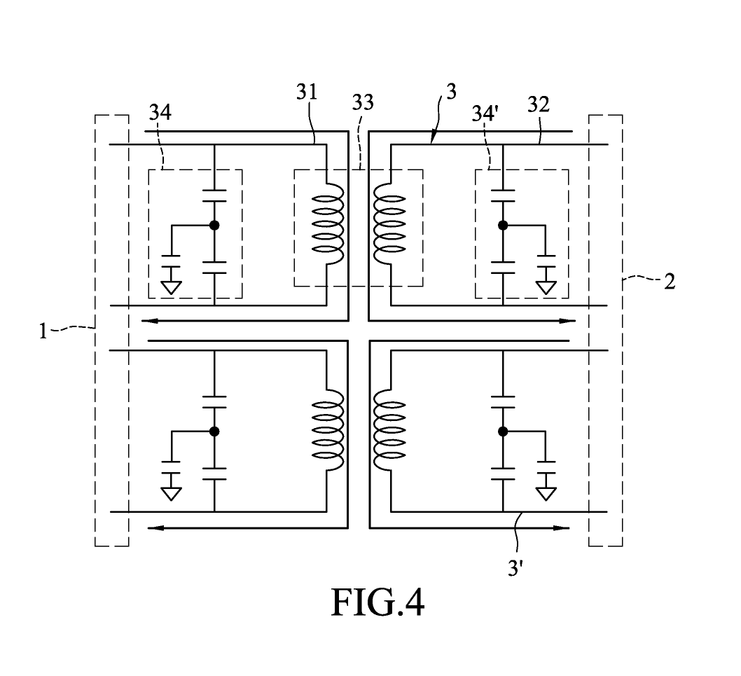

Since frequency of the network signal is lower than that of the common-mode noise, impedance of the first bypass capacitors 341 of the noise filtering module 34 is relatively high for the network signal, but relatively low for the common-mode noise. Similar situation applies to the noise filtering module 34′ as well. Consequently, the network signal would not flow through the noise filtering modules 34 and 34′ but is instead coupled by the isolation transformer 33 as shown in FIG. 4.

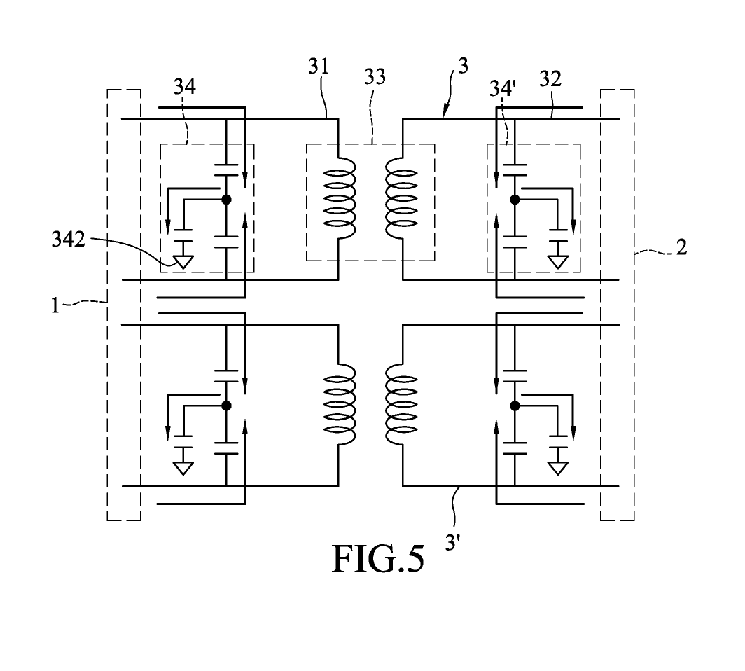

Comparatively, since the first bypass capacitors 341 of the noise filtering modules 34 and 34′ serve as short circuits for the common-mode noise due to the relatively high frequency thereof, the common-mode noise would not flow through the isolation transformer 33 but instead is grounded by the noise filtering modules 34 and 34′ as shown in FIG. 5. As a result, the common-mode noise is filtered and would not affect quality of the network signal.

Each of the first bypass capacitors 341 is designed to block the network signal but to allow passage of the common-mode noise to the ground. For example, given that the frequency of the network signal is 100 MHz, capacitance of each of the first bypass capacitors 341 may be designed to be 5 pF to block the network signal but to allow passage of the common-mode noise, which is of relatively higher frequency compared with the network signal, to the ground.

Because the noise filtering module 34 is connected between the forward path 311 and the return path 312 of the primary channel 31, and the noise filtering module 34′ is connected between the forward path 321 and the return path 322 of the secondary channel 32, the winding turns of the primary winding 331 and the secondary winding 332 would not be affected. That is to say, winding inductances of the isolation transformer 33 is not changed, and thereby errors would not be introduced while the primary winding 331 and the secondary winding 332 are inductively coupled.

In practice, the signal transmission unit 3 is a transmitter circuit, and the signal transmission unit 3′ is a receiver circuit. The transmission unit 3 as a transmitter circuit is able to transmit the network signal from the equipment to the cable. The transmission unit 3′ as a receiver circuit is able to receive the network signal from the cable and to transmit the network signal to the equipment. Therefore, a signal loop is formed.

It should be noted that in this embodiment, a total number of the signal transmission units 3 and 3′ is two, but the total number may be greater than two in other embodiments. Alternatively, the network device may include only one signal transmission unit 3 of the disclosure and a conventional signal transmission unit. In addition, a total number of the noise filtering modules 34 and 34′ in each signal transmission unit is two in this embodiment, but inclusion of only one noise filtering module is also feasible in other embodiments. Moreover, implementation of the noise filtering modules 34 and 34′ is not limited to this embodiment and may be combinations of other electronic components, such as combinations of inductors, diodes, or transistors.

By the design of the isolation transformer 33 in combination with the noise filtering modules 34 and 34′, the common-mode noise could be reduced by the noise filtering modules 34 and 34′ without affecting the winding turns of the primary winding 331 and the secondary winding 332, so that the errors of inductive coupling would be alleviated and the quality of the network signal may be improved. In addition, the design of the second bypass capacitor 344 protects the first bypass capacitors 341 from influence of lightning strikes.

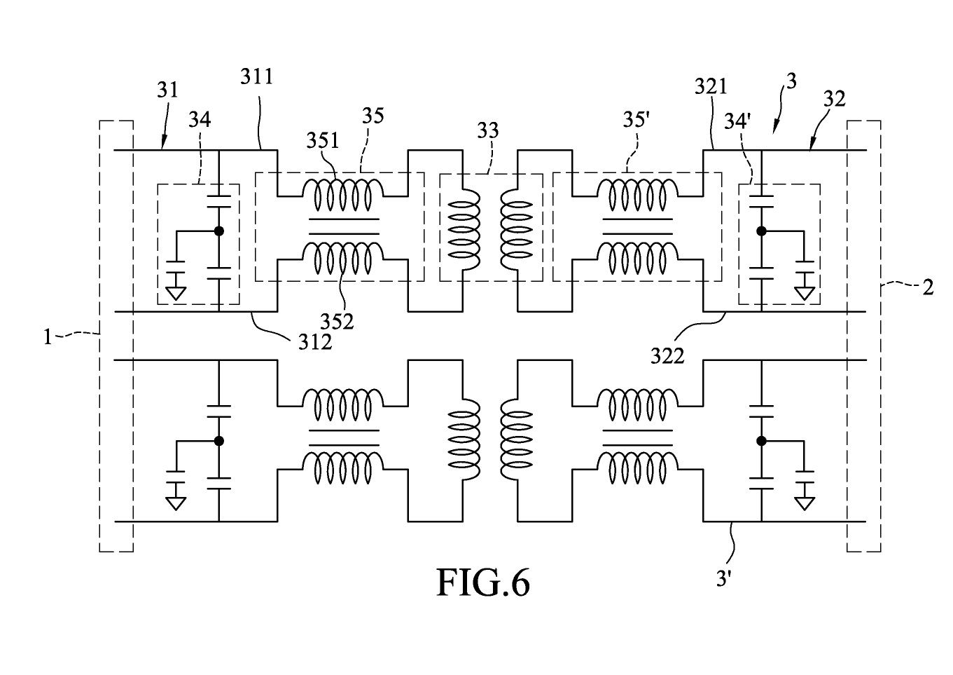

A second embodiment of the network device of this disclosure is illustrated in FIG. 6. The second embodiment is different from the first embodiment in that each of the signal transmission units 3 and 3′ further includes two common-mode choke modules 35 and 35′ electrically connected to the primary channel 31 and the secondary channel 32, respectively.

Because implementation of the common-mode choke module 35′ is similar to that of the common-mode choke module 35, only details of the common-mode choke module 35 will be described for the sake of brevity. The common-mode choke module 35 includes a first winding 351 electrically connected in series with the forward path 311, and a second winding 352 electrically connected in series with the return path 312.

Since magnetic flux caused by common-mode current in the primary winding 351 and magnetic flux caused by common-mode current in the secondary winding 352 are combined, a high impedance is presented by the common-mode choke, so that the common-mode noise is suppressed. Therefore, the design of the common-mode choke modules 35 and 35′ in cooperation with the noise filtering modules 34 and 34′ is capable of improving the quality of the network signal by reducing the common-mode noises of various frequencies.

It is noted that a total number of the common-mode choke modules 35 and 35′ in each of the signal transmission units 3 and 3′ is two in this embodiment. However, the total number may be one in other embodiments. Implementation of the common-mode choke is not limited to the embodiment disclosed herein.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A network device for interfacing network communication between equipment and a cable, and for filtering common-mode noise without changing winding inductances, said network device comprising:
an equipment port configured to be electrically connected to the equipment;
a cable port configured to be electrically connected to the cable; and
a signal transmission unit including a primary channel electrically connected to said equipment port for transmission of a signal, a secondary channel coupled to said primary channel and electrically connected to said cable port for transmission of the signal, an isolation transformer electrically connected between said primary channel and said secondary channel for coupling the signal from said primary channel to said secondary channel, and a noise filtering module electrically connected to one of said primary channel and said secondary channel for grounding common-mode noise.

2. The network device as claimed in claim 1, wherein:
said isolation transformer includes a primary winding electrically connected to said primary channel, and a secondary winding electrically connected to said secondary channel;
said primary channel has a forward path and a return path each of which is electrically connected between said equipment port and said isolation transformer, and electrically connected to a respective one of two ends of said primary winding so that said forward path, said primary winding and said return path are connected in series;
said secondary channel has a forward path and a return path each of which is electrically connected between said cable port and said isolation transformer, and electrically connected to a respective one of two ends of said secondary winding so that said forward path, said secondary winding and said return path are connected in series; and
said noise filtering module is electrically connected between said forward path and said return path of one of said primary channel and said secondary channel.

3. The network device as claimed in claim 2, wherein said noise filtering module includes two first bypass capacitors each of which is electrically connected to a respective one of said forward path and said return path, and is grounded.

4. The network processing device as claimed in claim 3, wherein each of said first bypass capacitors has a first end electrically connected to a respective one of said forward path and said return path, and a second end configured to be electrically connected to ground.

5. The network device as claimed in claim 4, wherein said noise filtering module is electrically connected to said primary channel, and said signal transmission unit further includes another noise filtering module which is electrically connected to said secondary channel for grounding common-mode noise.

6. The network device as claimed in claim 3, wherein said noise filtering module further includes a second bypass capacitor electrically connected between each of said first bypass capacitors and ground.

7. The network device as claimed in claim 3, wherein said noise filtering module is electrically connected to said primary channel, and said signal transmission unit further includes another noise filtering module which is electrically connected to said secondary channel for grounding common-mode noise.

8. The network device as claimed in claim 2, wherein said noise filtering module is electrically connected to said primary channel, and said signal transmission unit further includes another noise filtering module which is electrically connected to said secondary channel for grounding common-mode noise.

9. The network device as claimed in claim 1, wherein said signal transmission unit further includes a common-mode choke module electrically connected to one of said primary channel and said secondary channel.

10. The network device as claimed in claim 9, wherein said common-mode choke module is electrically connected to said primary channel, and said signal transmission unit further includes another common-mode choke module which is electrically connected to said secondary channel.

11. The network device as claimed in claim 9, wherein said noise filtering module is electrically connected to said primary channel, and said signal transmission unit further includes another noise filtering module which is electrically connected to said secondary channel for grounding common-mode noise.

12. The network device as claimed in claim 1, wherein said noise filtering module is electrically connected to said primary channel, and said signal transmission unit further includes another noise filtering module which is electrically connected to said secondary channel for grounding common-mode noise.
